(19) United States
(12) Patent Application Publication
(10) Pub. No.: US 2020/0321171 A1
(43) Pub. Date: Oct. 8, 2020

(54) Luminous Keycap and the Manufacturing Method Thereof

(71) Applicant: Huizhou Guocheng Electronics Co., Ltd., Huizhou City (CN)

(72) Inventors: Qiang Xiao, Huizhou City (CN); Jia Chen, Huizhou City (CN); Xiangxu Gao, Huizhou City (CN); Liang Chen, Huizhou City (CN)

(73) Assignee: Huizhou Guocheng Electronics Co., Ltd.

(21) Appl. No.: 16/397,698

(22) Filed: Apr. 29, 2019

(30) Foreign Application Priority Data
Apr. 2, 2019 (CN) 201910262675.6

(51) Int. Cl. H01H 13/83; G06F 3/02

(52) U.S. Cl. CPC H01H 13/83; H01H 2219/054; H01H 2219/036; G06F 3/0202

(57) ABSTRACT

A luminous keycap includes a base made of a light-transmitting material and a transparent cover, wherein the base is provided with a first light-shielding layer and the top surface thereof is provided with a first light-transmitting area, and the inner surface of the cover is provided with a second light-shielding layer. The surface of the second light-shielding layer directly opposite to the first light-transmitting area is engraved with a second light-transmitting area. The cover is correspondingly fixed onto the base. The method of manufacturing the same is also described. The keycap and the manufacturing method thereof achieve the goal that its user can accurately and swiftly use the keyboard in a dark environment. It solves the problem that the user often touches characters and/or patterns so often that they are worn away. It has a better touch, and the keycaps have a longer lifetime.

### FIELD OF THE INVENTION

The invention relates to keyboard technology and, in particular, to a luminous keycap and the manufacturing method thereof.

### BACKGROUND OF THE INVENTION

Most of the keycaps on existing keyboards are not transparent to light. In a dark environment, it is difficult for the user to identify the keycap, very inconvenient for keyboard operations. Moreover, the characters and/or patterns of the keycaps are printed on the surfaces thereof. As the user directly touches and feels the characters and/or patterns with fingers, the characters and/or patterns are often worn out or become unidentifiable.

### SUMMARY OF THE INVENTION

In view of the foregoing, it is an object of the invention to provide a luminous keycap and the method of fabricating the same.

To achieve the above object, the specific scheme of the present invention is as follows:

The disclosed luminous keycap comprises a base made of a light-transmitting material and a transparent cover, wherein the base is provided with a first light-shielding layer and the top surface thereof is provided with a first light-transmitting area, the inner surface of the cover is provided with a second light-shielding layer, and the surface of the second light-shielding layer directly opposite to the first light-transmitting area is engraved with a second light-transmitting area. The cover is correspondingly fixed onto the base.

A weakening layer for weakening light is disposed on the second light shielding layer.

The base and the cover are fixedly connected by dispensing or ultrasonic welding.

The base and the cover have a trapezoidal shape, and the top surfaces of the base and the cover are arranged to be curved.

The method of manufacturing the above-mentioned luminous keycap comprises the steps of:

S1: injection molding the cover with a transparent material, and injection molding the base using a transparent or translucent material;

S2: spraying a light-shielding paint of a color on the outer surface of the base, and leaving a first light-transmitting area on the top surface of the base, thereby forming a first light-shielding layer;

S3: spraying a paint of any color on the inner surface of the cover and then spraying on the inner surface of the cover 2 a light-shielding paint of silver, black or any other color that blocks light, thereby forming a second light shielding layer;

S4: removing part of the paint on the second light-shielding layer by laser engraving according to a desired character or pattern, thereby forming the character or pattern in the second light-transmitting area; and

S5: covering the cover on the base and fixing the cover to the base.

A weakening layer for weakening light is disposed on the second light shielding layer.

The base and the cover are fixedly connected by dispensing or ultrasonic welding.

The invention has the beneficial effects that: the disclosed keycap and the manufacturing method thereof can achieve the goal that the keyboard can be used accurately and swiftly by the user even in a dark environment, making the keyboard more convenient to use. The second light-shielding layer is disposed on the inner surface of the cover to achieve the purpose of weakening the light. This prevents reflection from the cover and avoids glare to the user in a long-time usage. Compared with the keycaps with transparent covers, the keycap of the present invention is visually thinner. Since the second light-transmitting area is disposed on the second light-shielding layer, the invention solves the problem that as the user touches and feels characters and/or patterns the characters and/or patterns are often worn away. Moreover, the keyboard feels better, and the keycaps have a longer lifetime.

### BRIEF DESCRIPTION OF THE DRAWINGS

FIG. 1 is a three-dimensional perspective view of the keycap according to an embodiment of the invention;

FIG. 2 is a schematic exploded view of the keycap according to an embodiment of the invention;

FIG. 3 is a cross-sectional view of the keycap according to an embodiment of the invention; and

FIG. 4 is a schematic exploded view of the keycap according to another embodiment of the invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

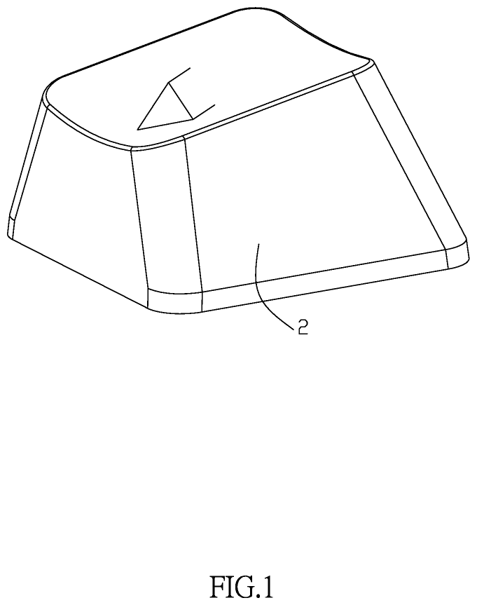

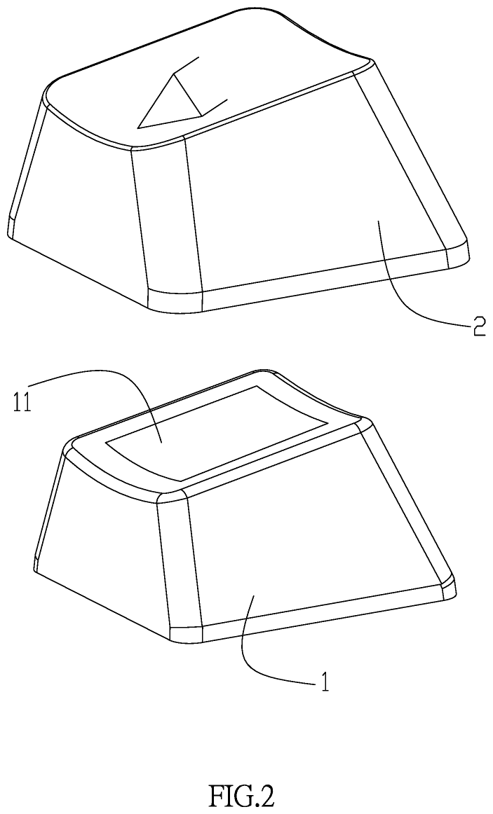

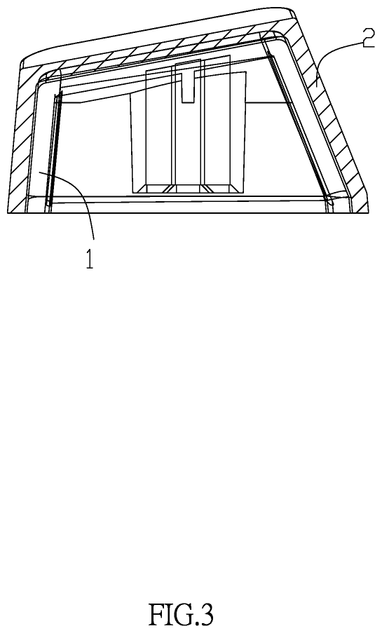

As shown in FIG. 1 to FIG. 3, the luminous keycap according to an embodiment of the invention includes a base 1 and a transparent cover 2. The base 1 is made of a transparent material, and is provided with a first light-shielding layer, with a first light-transmitting area 11 formed on the top surface thereof. The inner surface of the cover 2 is provided with a second light-shielding layer. The surface of the second light-shielding layer opposite to the first light-transmitting area 11 is engraved with a second light-transmitting area using laser. The second light-transmitting area has the shape of a character or pattern, such as the character ‘A’ shown in FIGS. 1 and 2. The cover 2 covers the base 1 and is fixedly connected to the base 1. Two or more second light-transmitting areas can be provided on a keycap to satisfy different functional needs thereof.

Preferably, the base 1 is made of a milky white translucent material to facilitate weakening of the light. To install, one puts the keycap on the keyboard, covering the light source of the keyboard. After the keyboard is powered, the light is concentrated toward the first light-transmitting area 11 of the base 1 due to the shield of the first light-shielding layer thereon, illuminates the second light-shielding layer on the cover 2, and emits from the second light-transmitting area. The keycap is thus illuminating, so that the user can quickly identify each keycap in a dark environment. This is more convenient for users to use. The second light-transmitting area with the shape of a character or pattern is provided on the inner surface of the cover 2. The user does not have a direct contact with the second light-transmitting area, thereby achieving the effect that characters and/or patterns never fade or wear away. This nicely solves the problem that the user often touches characters and/or patterns to make them worn away. The keyboard has a better touch, and the lifetime of the keycap is extended.

Compared with the transparent cover 2, this embodiment looks thinner as the second light-shielding layer is provided on the inner surface of the cover 2. Light passing through the keycap looks softer, thereby avoiding the reflective glare from the cover 2. At the same time, light is prevented from leaking out from the bottom of the base 1, making the keyboard more layered.

Based on the above embodiment, a weakening layer for weakening light intensity is further disposed on the second light shielding layer to weaken the intensity of the light, making the light look softer. Especially for the base 1 made of the transparent material, the light is weakened to protect user's eyes from dazzling when the keyboard is used for a long time.

Based on the above embodiments, the base 1 and the cover 2 are fixedly connected by means of dispensing or ultrasonic welding, so that the connection between the base 1 and the cover 2 is more secure and reliable than the method of clamping. In this embodiment, the connection between the base 1 and the cover 2 can be prevented from detachment due to vibrations during the transportation of the keycap. When the dispensing method is used, the glue is applied to the base 1 and then the cover 2 is attached to the base 1 and bonded together to form a keycap. When the ultrasonic welding method is used, one covers the cover 2 on the base 1 and then ultrasonically weld them to form a keycap.

Based on the above embodiments, both the base 1 and the cover 2 have a trapezoidal shape. The top surfaces of the base 1 and the cover 2 are arranged in a curved surface, which is more suitable for the structure of the keyboard. The keycap fits better to user's fingers, providing better touch and more comfort.

As shown in FIG. 1 to FIG. 3, the method for manufacturing the above-mentioned keycap includes the following steps:

S1: injection molding the cover 2 with a transparent material, and injection molding the base 1 using a transparent or translucent material;

S2: spraying a light-shielding paint of a color on the outer surface of the base 1, and leaving a first light-transmitting area 11 on the top surface of the base 1, thereby forming a first light-shielding layer;

S3: spraying a paint of any color on the inner surface of the cover 2 and then spraying on the inner surface of the cover 2 a light-shielding paint of silver, black or any other color that blocks light, thereby forming a second light shielding layer;

S4: removing part of the paint on the second light-shielding layer by laser engraving according to a desired character or pattern, thereby forming the character or pattern in the second light-transmitting area, such as the character ‘A’ shown in FIGS. 1 and 2;

S5: covering the cover 2 on the base and fixing the cover 2 to the base 1.

The base 1 and the cover 2 are fixedly connected by dispensing or ultrasonic welding.

It is found that the second light-shielding layer disposed on the inner surface of the cover 2 can effectively prevent the dust from depositing on the inner surface thereof. It does not interfere user's usage, and maintains the aesthetic effect of the keycap for a longer time.

However, occasionally, dust may enter the second light-transmitting area, thereby preventing the light from coming out of the second light-transmitting area. This results in incomplete transparency for the second light-transmitting area in the shape of a character or pattern. This seriously affects the aesthetic and light-transmitting effects of the keycap, and is not good for the user's operating experience. In order to further eliminate the problem of dust, the invention offers yet another structure of the keycap.

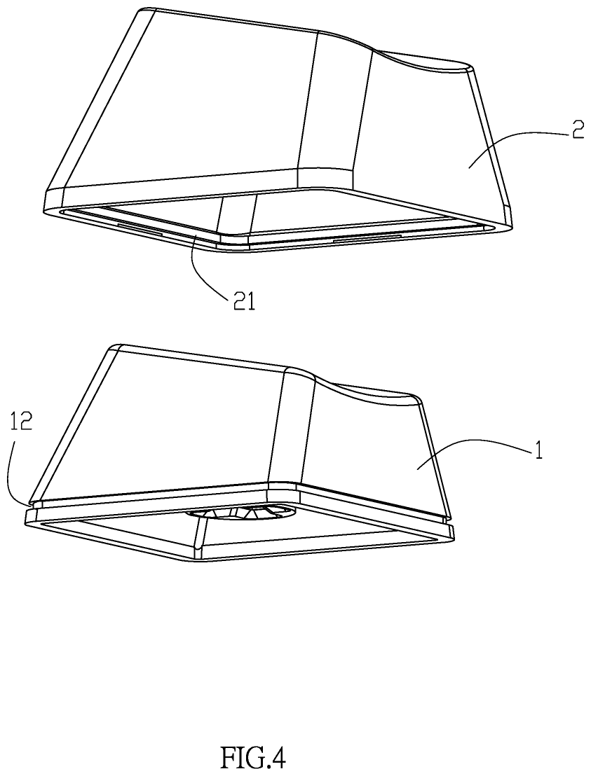

As shown in FIG. 4, the difference between the present embodiment and the above-mentioned embodiment is that a dustproof recess 12 is provided along the periphery of the outer wall of the base 1. A dustproof ridge 21 is provided on the periphery of the inner wall of the cover 2 corresponding to the dustproof recess 12. The rest of this embodiment is the same as the above-mentioned embodiment. Please refer to the previous embodiment for the features that are not explained in this embodiment. When the cover 2 covers the base 1. the dustproof ridge 21 is embedded in the dustproof recess 12, so that dust can be effectively prevented from entering between the base 1 and the cover 2. As a result, the second light-transmitting area on the cover is not dusted, thus fundamentally solving the problem with dust. This ensures user's long-term good experience and maintains the aesthetic effect of the keycap. Moreover, the connection between the cover 2 and the base 1 can be further fixed, to facilitate the dispensing or ultrasonic welding of the keycap. In addition, it has been found that the keycap provided with the dustproof groove 12 and the dustproof ridge 21 has a more prominent shape of the second light-transmitting area on the keycap when lighted. Without the dust groove 12 and the dust ridge 21, on the other hand, the edge of the second light-transmitting area is darker than the other parts. The central area is relatively bright and clear, giving the user a fuzzy feeling. This is because the edge of the second light-transmitting area has the second light-shielding layer to absorb the light. The use of the dustproof groove 12 and the dustproof ridge 21 can change the original reflection path of light, thereby compensating the for the edge of the second light-transmitting area. The shape of the second light-transmitting area thus looks clearer and brighter.

Of course, a sealing ring can be embedded on the periphery of the outer wall of the base 1 or the periphery of the inner wall of the cover 2 to achieve the effect of dustproofing. But the sealing ring has thermal expansion and contraction. In this case, dust can also accumulate between the base 1 and the cover 2.

The manufacturing method of the keycap in this embodiment is different from the manufacturing method of the previous embodiment in that, after step S1 there is a step of injection molding the dustproof groove 12 on the periphery of the outer wall of the base 1 and the dustproof ridge 21 on the periphery of the inner wall of the cover 2. The rest steps are the same as the method in the previous embodiment.

By adopting the disclosed keycaps and the manufacturing method thereof, the keyboard can be accurately and quickly used by the user even in a dark environment. It is very convenient. The second light-shielding layer is disposed on the inner surface of the cover 2 to weaken the light, preventing reflection glare from the cover 2 to tire user's eyes after a long-time usage. The keycap is also visually thinner. The second light-transmitting area is disposed on the second light-shielding layer. As a result, the characters and/or patterns on the keycap would not be worn away after frequent touches of the user. It provides a better touch, with a longer lifetime for the keycaps.

The dustproof groove 12 disposed on the base 1 and the dustproof ridge 21 disposed on the cover 2 can effectively prevent dust from entering between the base 1 and the cover 2. It fundamentally solves the problem of dust accumulation between the cover 2 and the base 1. The user can have a better usage experience, with the keycaps maintaining its aesthetic effect for a long time.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

1. A luminous keycap, comprising a base and a transparent cover, wherein
the base is made of a transparent material, provided with a first light-shielding layer, and a first light-transmitting area formed on the top surface thereof;
the inner surface of the cover is disposed with a second light-shielding layer;
the surface of the second light-shielding layer opposite to the first light-transmitting area is engraved with a second light-transmitting area by laser; and
the cover covers the base and is fixedly connected to the base.

2. The luminous keycap of claim 1, wherein the second light-shielding layer is disposed with a weakening layer for weakening light.

3. The luminous keycap of claim 1, wherein the base and the cover are fixedly connected by dispensing or ultrasonic welding.

4. The luminous keycap of claim 1, wherein both the base and the cover have a trapezoid shape, and the top surfaces of the base and the cover are arranged to be curved.

5. A method for manufacturing a luminous keycap, comprising the steps of:
S1: injection molding the cover with a transparent material, and injection molding the base using a transparent or translucent material;
S2: spraying a light-shielding paint of a color on the outer surface of the base, and leaving a first light-transmitting area on the top surface of the base, thereby forming a first light-shielding layer;
S3: spraying a paint of any color on the inner surface of the cover and then spraying on the inner surface of the cover a light-shielding paint of silver, black or any other color that blocks light, thereby forming a second light shielding layer;
S4: removing part of the paint on the second light-shielding layer by laser engraving according to a desired character or pattern, thereby forming the character or pattern in the second light-transmitting area; and
S5: covering the cover on the base and fixing the cover to the base.

6. The method of claim 5, wherein the second light-shielding layer is disposed with a weakening layer for weakening light.

7. The method of claim 5, wherein the base and the cover are fixedly connected by dispensing or ultrasonic welding.

8. The method of claim 6, wherein the base and the cover are fixedly connected by dispensing or ultrasonic welding.
